(19) United States
(12) Patent Application Publication
(10) Pub. No.: US 2005/0188857 A1
(43) Pub. Date: Sep. 1, 2005

(54) Container for gastronomic use

(76) Inventor: Roberto Vincenzo Garziera, Appiano Gentile (Como) (IT)

Correspondence Address: Kirschstein, Ottinger, Israel & Schiffmiller, P.C., 489 Fifth Avenue, New York, NY, 10017-6105, US

(21) Appl. No.: 10/980,451

(22) Filed: Nov. 3, 2004

(30) Foreign Application Priority Data
Nov. 4, 2003 (IT) MI2003A-002118

(51) Int. Cl. A47J 37/12

(52) U.S. Cl. 99/403

(57) ABSTRACT

A container for gastronomic use includes a substantially cylindrical receptacle; at least two attachment lugs, connected to the walls of the container; at least two handles, coupled to the attachment lugs through an articulated coupling system. The handles are arranged, in a simple manner, in at least two positions of which one is a raised position, in which the handles radially extend from the walls of the receptacle and the other is a lowered position, in which the handles are arranged near the walls, to allow the container to be located inside another container having a like shape and a slightly larger size. A locking device locks the handles in the raised position.

### BACKGROUND OF THE INVENTION

Containers used for gastronomic applications have several shapes and denominations, some of which, of common use are, for example: pan, pie-dish, frying pan, saucepan, stewpan, cauldron, pot, stockpot.

The present invention relates to each of them, or other possible constructions and denominations, provided that they are referred to a gastronomic use container comprising at least a receptacle and at least two handles. For practicality purposes, in the following disclosure, terms such as “saucepan” and “container for gastronomic use” will be considered as equivalent.

Saucepans generally comprise a receptacle or vessel including one or more handles, which are radially extended from the walls of said receptacle and are fixedly coupled thereto.

In a lot of occasions, however, the handles prevent an ordered and efficient arrangement of saucepans from being obtained. This occurs, by way of a non limitative example, in packaging and sending operations, or as one desires to arrange said saucepans in dishwashers, refrigerators, furniture pieces, shelves and so on.

A feature negatively affected by the provision of the projecting handles is the so-called “stacking” capability or, more precisely, the possibility of arranging saucepans within one another.

A set of saucepans, adapted to the most common culinary requirements, conventionally comprises, inter alia, a number of saucepans, also called “stewpans”, having a like, mostly cylindric, shape, and increasing diameters, starting from a minimum one, and slightly different from one another. By way of a non limitative example, a saucepan set could comprise a series of stewpans or casseroles having diameters of 120, 150, 180, 210, 240, 280, 320 millimeters. On the other hand, the above saucepans are usually provided with two handles which radially project for a distance which, by way of a non limitative example, varies from 40 to 80 millimeters.

Thus, some saucepans forming a saucepan set could be arranged, according to an increasing size order, each within the next, if exclusively the size of the cooking receptacle would be considered: however, this is not possible because of the provision of the handles.

A prior solution for overcoming the above mentioned drawback, is that of providing a saucepan with removable handles. However, such an approach is affected by some drawbacks: it provides a non perfectly reliable gripping capability; compels to use rather large handles and attachment lugs; and involves a separate handling of the saucepan receptacles and handles.

Yet another prior approach for limiting the saucepan arrangement problems due to the provision of the projecting handles therefor is that of applying to gastronomic use containers, a hinged or articulated type of handles. Such handles usually comprise metal moldings, pivoted at the end portions thereof, which are lowered because of their weight and must be raised as one desires to grip them. Such an approach is sometimes adopted, for example, in oven pie-dish of mostly rectangular shape; however, it provides an uncomfortable and unreliable gripping in the most part of other gastronomic uses.

### SUMMARY OF THE INVENTION

The aim of the present invention is to overcome the above mentioned drawbacks and, in particular, provide a gastronomic use container having two handles which can stably assume a raised position in which, by radially extending from the walls of said container, they will provide a comfortable and safe gripping, and a lowered position in which, by approaching as far as possible to the walls of said container, they will greatly reduce the occupied space thereof, thereby allowing said container to be, inter alia, arranged inside another container having an analogous shape and a slightly larger size.

Another object of the present invention is to provide such a container for gastronomic use including two articulated container handles, which can be simply made and at a comparatively low cost.

According to the present invention, the above and other objects are achieved by a container for gastronomic use according to Claim 1.

Further features being defined in the following claims.

### BRIEF DESCRIPTION OF THE DRAWINGS

Further characteristics and advantages of a container for gastronomic use according to the present invention will become more apparent from the following disclosure, given by way of a non limitative example, with reference to the schematic accompanying drawings, where:

FIG. 1 is an isometric view of an articulated handle applied to a portion of an oven rectangular pie-dish, according to the prior art;

FIG. 2 is an isometric view of a container for gastronomic use according to the invention, one of the handle of which is in a raised position and the other being in a lowered position;

FIG. 3 is a top plan view of the container shown in FIG. 2, with a like container, of slightly less size, engaged therein;

FIG. 4 is a cross-sectional view, taken along a diameter joining the middle line of the handle, of the container of FIG. 2, in which has been engaged an analogous container having a slightly less size;

FIG. 5 shows several isometric views of a possible embodiment of an attachment lug for a container according to- the invention;

FIG. 6 is an isometric view of a possible embodiment of a handle for a container according to the invention;

FIG. 7 is a further isometric view, taken along a symmetry axis of the assembly comprising the attachment lug of FIG. 5 and handle of FIG. 6, coupled to one another, the handle being shown in a raised position:

FIG. 8 is an isometric cross-sectional view passing through the axis of the hinge of the assembly shown in FIG. 7, with the handle being shown in a lowered position;

FIG. 9 is an isometric view of a modified embodiment of a handle for a container according to the invention;

FIG. 10 is an isometric view of another modified embodiment of an attachment lug for a container according to the invention; and

FIG. 11 is an isometric view of the handle shown in FIG. 9 and attachment lug shown in FIG. 10, being coupled to one another.

### DESCRIPTION OF THE PREFERRED EMBODIMENTS

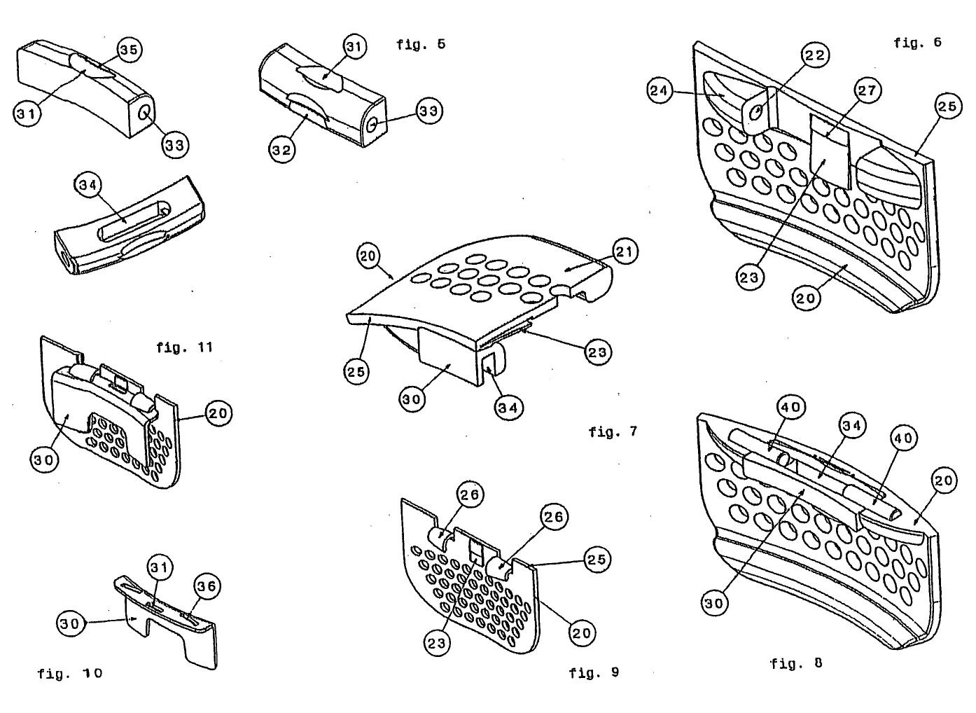

With reference to FIGS. 2 to 8, a saucepan 10, comprising a substantially cylindric container or receptacle 11, to the walls of which are coupled, at a set height, two attachment lugs 30, at diametrically opposite positions, is herein shown. As shown in FIGS. 5, 7 and 8, said attachment lugs comprise two holes 33, a slot 34, a recess 31 and a further recess 32.

Handles 20 are coupled, through holes 22 formed in bulged portions 24, to the attachment lugs 30 through pins 40 passing through respective holes 33. The provision of the slot 34 allows said pins 40 to be easily engaged. As shown in FIGS. 3 and 4, the assembly comprising the handles 20, at a lowered position thereof, coupled to the attachment lugs 30 and assembled to the container or receptacle 11, is so advantageously made as to be delimited by a cylindric surface, concentric with the receptacle 11 itself, coinciding with the surface 21, thereby further reducing the space occupied thereby and allowing the container 10 to be arranged inside another like container having a slightly larger diameter.

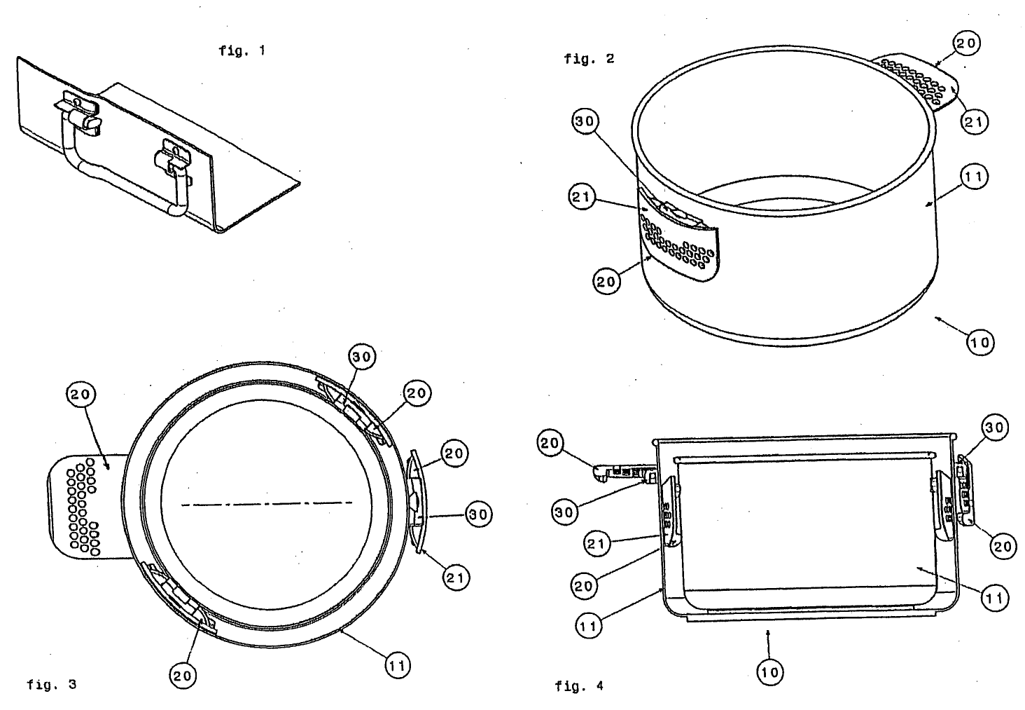

It should be apparent that, after having coupled the attachment lugs 30 to the walls of the receptacle 11 and applied the handles 20, the latter will be adapted to assume, with respect to said walls, an exclusively rotary movement about the axis of the pins 40. Thus, said handles 20 can be brought to a lowered position, in which they will abut against the walls of the receptacle 11, and a raised position, in which they will radially extend from said walls, so as to bring the extrados point 25, into contact with said walls. As shown in FIG. 7, a locking device, comprising, by way of a non limitative example, the spring tongue 23 which, as it is caused to enter the recess 31, brings the projections 27 and 35 in abutment onto one another, allows to lock the handles 20 in said raised position, thereby rendering the latter a stable position, and providing a comfortable gripping (differently from that occurs, for example, in systems like that shown in FIG. 1). To unlock the handles 20, it is sufficient to apply to said spring tongues 23 a upward directed pressure, and then turn downward said handles. With the handles in their lowered position, the spring tongues 23 are engaged in recesses 32.

The above disclosed embodiment of the gastronomic use container according to the invention is well adapted for making, by way of a non limitative example, metal cast or pressed single-block attachment lugs and thermoplastic resin handles (by way of a non limitative example, of phenolic resins or fluoridized resins) in which said tongues 23 are formed in a single piece.

Another possible embodiment, shown, by way of a non limitative example, in FIGS. 9, 10 and 11 provides to make the attachment lugs of metal sheet material (which is well adapted, by way of a non limitative example, to be electro-welded to the walls of the receptacle 11) and of the handle also of a metal sheet material or of thermoplastic resins. In such an embodiment, the hinges are directly formed as a single piece both in the attachment lug, through the slots 36, and in the handle, through the frustum of cone moldings 26.

Even if only two embodiments of the gastronomic use container according to the invention have been above illustrated, it should be apparent that it would be possible to make yet other embodiments thereof. Thus, the gastronomic use container according to the invention provides a lot of advantageous features, such as:
a small occupied space or size;
a possibility of arranging a container inside another like container having a slightly larger size;
a self-evident and reliable use;
a high constructional and assembling simplicity.

Finally, it should be apparent that the gastronomic use container, as disclosed, is susceptible to several modifications and variations, all of which will come within the scope of the invention; moreover, all the details can be replaced by other technically equivalent elements.

In practicing the invention, the used, materials, as well as the contingent shape and size can be any, depending on technical requirements.

Thus, the scope of the invention will be defined by the accompanying claims.

1-5. (canceled)

6. A container for gastronomic use, comprising:
a) a substantially cylindrical receptacle having receptacle walls;
b) at least two attachment lugs fixed to said walls of said receptacle;
c) at least two handles coupled to said attachment lugs by an articulated coupling system operative for arranging said handles in a raised position, in which the handles radially extend from said walls of said receptacle, and in a lowered position, in which the handles are arranged near said walls, thereby allowing said container to be arranged inside another container having a like shape and a slightly larger size; and
d) a locking device for locking said handles in said raised position.

7. The container for gastronomic use according to claim 6, wherein said attachment lugs are made as a metal pressed single block, and wherein said handles are made of thermoplastic resins.

8. The container for gastronomic use according to claim 6, wherein said attachment lugs are made of a metal cast single block, and wherein said handles are made of thermoplastic resins.

9. The container for gastronomic use according to claim 6, wherein said attachment lugs are made of a metal sheet material, and wherein said handles are made of thermoplastic resins.

10. The container for gastronomic use according to claim 6, wherein both said attachment lugs and said handles are made of a metal sheet material.
